(19) United States
(12) Patent Application Publication
(10) Pub. No.: US 2005/0168750 A1
(43) Pub. Date: Aug. 4, 2005

(54) MEASUREMENT SYSTEM FOR DETERMINING THE THICKNESS OF A LAYER DURING A PLATING PROCESS

(75) Inventors: Christian Laue, Mainz (DE); Theodore van Kessel, Millbrook, NY (US); Frederick Maurer, Valhalla, NY (US)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERANTIONAL BUSINESS MACHINES CORPORATION, Armonk, NY (US)

(21) Appl. No.: 10/905,583

(22) Filed: Jan. 12, 2005

(30) Foreign Application Priority Data
Feb. 2, 2004 (EP) 04100360.9

(51) Int. Cl. G01B 9/02

(52) U.S. Cl. 356/477

(57) ABSTRACT

A method and a measurement system to provide an in situ measurement of the thickness of a layer deposited on a substrate is described. The measurement system includes the optical sensor integrated into a movable element hovering over the substrate in close proximity to the layer. The optical sensor element is adapted to emit and detect optical signals. The measurement system provides an optical, and thus contactless approach to determine the thickness of the layer during the growth of the layer. The inventive measurement system is particularly suited for an electroplating system and process.

### BACKGROUND OF THE INVENTION

The present invention relates to the manufacture of an end point sensor integrated in an electroplating apparatus, and more particularly, to a method and a system for providing in situ measurement of the thickness of a layer during an eletroplating process.

The deposition of a metallic layer on a substrate is typically realized by means of electroplating a physical vapor deposition (PVD) or by way of a chemical vapor deposition (CVD)process. Electroplating is based on electrically connecting a substrate to an electrode and immersing the substrate in a solution containing metal ions. A metallic layer is then grown on the substrate as a result of precipitating the metal ions on the substrate. In order to deposit a structured or patterned metallic layer on the substrate, one can effectively make use of photoresist layer that has been structured by means of a lithography process. The photoresistant layer allows for an interstitial deposition of metal ions. Upon completing the plating process, the photoresist is removed, leaving the structured metallic layer on the substrate.

Measuring the thickness of a deposited metallic layer is performed sequentially, i.e., following the electroplating process by making use of profilometry. Since measurements cannot be performed within the electroplating cell, i.e., in situ, the thickness of the deposited layer is only measured after removal of the photoresist and outside the electroplating cell, which is rather disadvantageous when the deposited layer has not achieved the required thickness. Hence, appreciable scrap is created, and the entire electroplating process is repeated with another substrate. Thus, an insufficient plating process is costly and should be avoided.

Another approach for determining the thickness of a structured layer resulting from the electroplating process makes use of white light interferometry. Exposing a structured layer to light from a broadband light source, such as a tungsten halogen or similar incandescent light source, results in an interference pattern when light is reflected on different boundaries of the substrate. The layer deposited and the photoresist (when present) feature a different thickness that leads to distortions in the phase front of the reflected light. Detection followed by analyzing the reflected light by way of a spectrometer provides reliable information on the thickness of the layer.

Optical measurement techniques, and in particular white light interferometry, are advantageously compared to profilometry because the thickness of the layer is determined in a contactless way. Moreover, the thickness of a layer is effectively determined prior to the removal of the photoresist, which allows continuing the ion deposition process until the optimum thickness is reached. Thickness measurement techniques that cause the photoresist to remain on the substrate are essential for the generation of multi-layer structures where the same layer of photoresist is repeatedly used when depositing many different layers on the substrate.

In the prior art, measuring the layer thickness in an electroplating process cannot be performed in situ, i.e., the layer thickness cannot be measured within an electroplating cell during an electroplating deposition process. Depositing a layer and measuring its thickness must be performed sequentially at different locations. Since a galvanic solution within an electroplating cell typically resembles a non-transparent slurry, optical measurements of the layer thickness from outside the electroplating cell during the electroplating process is not practical. This is due to high absorption losses that are experienced by light beams propagating through the galvanic solution.

Thus, there is a need in industry for a method and an optical measurement system for determining the thickness of a layer during an electroplating process, and for providing an in situ measurement system to achieve these results.

### SUMMARY OF THE INVENTION

The invention provides a measurement system for determining the thickness of a layer grown on a substrate. The measurement system includes a movable element hovering over the substrate in close proximity to the layer. The system further includes an optical sensor integrated into the movable element. The optical sensor emits first optical signals to the substrate and detects second optical signals that are reflected from the substrate.

The optical sensor is integrated into the movable element that is directed toward the substrate. The movable element is arranged to minimize the distance between the movable element and the substrate to provide a minimal propagation distance of the first and second optical signals between the optical sensor integrated into the movable element and the substrate.

The substrate having a planar geometry and the movable element moves with respect to two degrees of freedom corresponding to the plane of the substrate. For determining the thickness of the layer during the growth process, the movable element is not require to actually move, in which case, the thickness measurement is restricted to a single inspection point of the substrate.

When the movable element moves in close proximity to the substrate, the distance between the movable element and the substrate remains constant within slight variations. Care is required to ensure that the movable element or the optical sensor is in mechanical contact with the substrate or the layer growing on the substrate. In typical embodiments of the invention, the distance between the movable element and the substrate does not exceed a few millimeters. By minimizing the distance between the optical sensor and the substrate, minimal absorption losses of the optical signals are achieved as well as a minimal distortion of the optical wave front arising from the optical properties of the surrounding medium.

Second optical signals are generated by reflecting the first optical signals on the surface of the layer, the substrate or the photoresist. Therefore, the layer, the substrate and the photoresist exhibit a non-zero reflection coefficient for the wavelength of the first optical signals. The second optical signals detected by the optical sensor are indicative of the thickness of the layer. The layer thickness is determined by further processing of the second optical signals by analyzing either the optical spectrum, the spatial structure, the wave front or the intensity of the second optical signals.

According to another aspect of the invention, the substrate makes electrically contact to an electrode of the electroplating cell and the growth process of the layer is realized by an electroplating deposition process immersed in a galvanic solution. Applying a DC voltage to the substrate induces precipitation of the metallic ions of the galvanic solution. In a preferred embodiment of the invention, the movable element actually stirs the galvanic solution during the plating process. Constantly moving the movable element in close proximity to the substrate therefore provides a homogeneous deposition of metallic ions on the substrate.

The movable element in combination with the optical sensor therefore provide an in situ determination of the layer thickness during an electroplating process immersed in a galvanic solution featuring a high absorption coefficient for the optical wavelength in use due to the small distance between the optical sensor and the layer. The reflected optical signals only experience limited absorption and are detected by the optical sensor.

According to a further aspect of the invention, the lack of uniformity of the layer grown is effectively detected. Since the optical sensor is integrated into the movable element, second optical signals are advantageously detected at different locations of the planar substrate. By comparing the optical signals detected at different positions on the substrate, variations of the layer thickness is precisely measured. Thus, the inventive measurement system not only provides an in situ measurement of the layer thickness but also provides an in situ measurement of the lack of uniformity of the growing layer.

According to yet a further aspect of the invention, the optical sensor includes an optical fiber emitting first optical signals and detecting second optical signals reflected from the substrate. The optical fiber further transmits first optical signals from a light source and second optical signals to a processing unit. Thus, the source of the optical signals does not need to be integrated into the measurement system. The optical signals are transmitted to the optical sensor from an external source generating the optical signals. The transmission of first and second optical signals are realized by the same optical fiber or by a plurality of different optical fibers. Typically, the optical fiber transmits optical signals from the light source to the optical sensor, and a other optical fibers transmit the detected second optical signals to the processor.

According to still another aspect of the invention, the optical sensor includes an optical imaging system directing first optical signals to the substrate and then coupling the second optical signals to the optical fiber. By means of the optical imaging system, the spatial expansion of the first and the second optical signals are effectively controlled. Thus, the size of the substrate area exposed by the optical signals can effectively be manipulated.

According to a further aspect of the invention, the optical sensor includes a mirror for reflecting the first optical signals to the substrate and the second optical signals to the optical fiber. The mirror reflects and redirects two counter-propagating optical signals. In essence, optical deflection means for exposing the substrate and for detecting the reflected optical signals are incorporated in an optical component. Consequently, the imaging system of the optical sensor preferably consists of only one optical component.

According to a further aspect of the invention, the optical sensor further includes a retro-reflecting element forming an aperture for the first and second optical signals. The retro-reflecting element is positioned to reflect the second optical signals on the substrate. Since the retro-reflecting element redirects the propagation direction of the optical beam by exactly 180°0, the optical signal reflected by the substrate that subsequently impinges the retro-reflecting element reverses its direction of propagation, returns to the substrate and is reflected by the substrate to enter the optical sensor in the same manner as it previously emerged from the optical sensor.

The retro-reflecting element provides a non-perpendicular propagation of optical signals with respect to the plane of the substrate. The aforementioned feature effectively lowers the alignment requirements of the optical signals and facilitates the alignment. Moreover, by making use of the retro-reflecting element, the intensity of the detected second optical signals is significantly enhanced since the second optical signals propagate exactly as the first optical signals but in the reversed direction. Furthermore, the loss of optical intensity is reduced to a minimum. Optimally, the intensity losses are substantially reduced by absorption losses in the galvanic solution, as well by reflection losses on the reflecting surfaces of the mirror, the substrate, the photoresist and the layer. The retro-reflecting element therefore provides an effective way for returning the entire optical energy of the first optical signals to the optical sensor.

According to a still another aspect of the invention, the movable element features an elongated shape with the optical sensor moving along the movable element. Assuming that the movable element is elongated in a first direction and moves along a second direction perpendicular to the first, with the first and second directions lying in the plane of the substrate, by moving the movable element into the second direction and the optical sensor in the first direction, the entire two dimensional planar structure of the substrate or the layer is precisely scanned and analyzed.

According to yet another aspect of the invention, the spectral range of the first optical signals emerging from the optical sensor is substantially equal to the spectrum of visible light, i.e., the source of optical energy is a broadband tungsten halogen light source or similar incandescent source. Making use of broadband white light to form the first optical signals, the second optical signals reflected from the surface of the substrate or the layer represent a white light interference pattern indicative of the layer thickness. A white light interference pattern evolves since the white light reflects on the substrate and the layer or the remaining photoresist have a different thickness. The thickness of the layer is effectively determined by spectral analysis of the detected white light interference pattern since the various wavelength components of the white light have different phase shifts when they are reflected on the substrate.

According to yet a further aspect of the invention, the thickness of the deposited layer is also determined in a non-interferometric manner by the absorption and/or transmission measurement of the growing layer. This alternative manner of determining the layer thickness is only possible when the layer is transparent for the optical signals in use. Having knowledge of the absorption or transmission coefficient of the layer material, the thickness of the layer is effectively determined by measuring the intensity of optical signals that are reflected from the surface of the substrate and are subject to absorption when propagating through the exposed layer.

In yet another aspect of the invention, there is provided a method for determining the thickness of a layer during a growth process of the layer on the substrate. The method includes the steps of having a movable element hover over the substrate in close proximity to the layer, emitting first optical signals from the optical sensor integrated within the movable element and detecting second optical signals by the optical sensor that are reflected from the substrate. The thickness of the layer is effectively determined by analysis of the second optical signals during the deposition phase, e.g., electroplating.

The present invention therefore provides a method and a system to provide an in situ measurement of the thickness of a layer during a deposition process. The invention is effectively applied to the manufacture of an end point sensor integrated within an electroplating apparatus. By repeatedly measuring the layer thickness during a ion deposition process, the end point sensor indicates when a required layer thickness is reached at which point the plating process terminates.

### BRIEF DESCRIPTION OF THE DRAWINGS

The accompanying drawings, which are incorporated in and which constitute part of the specification, illustrate presently preferred embodiments of the invention which, together with the general description given above and the detailed description of the preferred embodiments given below serve to explain the principles of the invention.

FIG. 1 illustrates a perspective view of the measurement system, in accordance with a preferred embodiment of the invention.

FIG. 2 is a cross-section view of the movable element and the optical sensor, in accordance with a preferred embodiment of the invention.

FIG. 3 shows a bottom view of the movable element within the integrated optical sensor.

FIG. 4 shows a cross-section view of the movable element within the integrated optical sensor when in an operational mode.

FIG. 5 shows an enlarged view of the substrate including the photoresist and the exposed layer.

FIG. 6 is a schematic diagram of the measurement system in combination with a light source and a processing unit.

### DETAILED DESCRIPTION

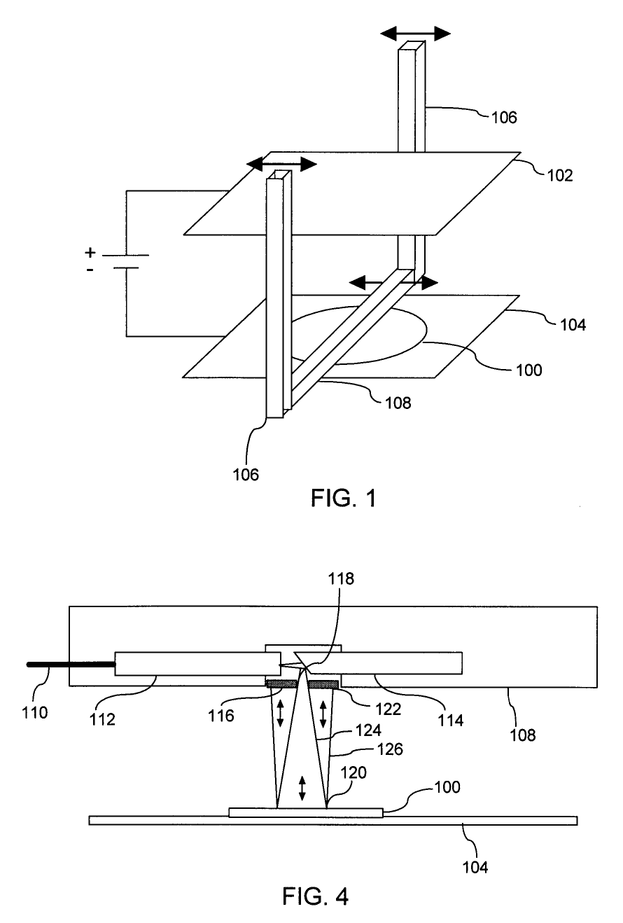

Referring now to FIG. 1, there is shown a perspective view of the measurement system. In the preferred embodiment, the measurement system is integrated in the electroplating system, preferably immersed in a galvanic solution. The system includes an upper electrode 102 and lower electrode 104. In order to induce precipitation of ions at the electrodes, the upper and lower electrodes 102, 104 are electrically connected to a DC voltage supply. A substrate 100 is positioned on top of the lower electrode 104, making electrical contact with the lower electrode 104. The substrate having a layer of photoresist provides the basis for interstitial deposition of ions of the galvanic solution, providing a spatially structured layer to grow on the substrate.

A movable element 108 is adapted to hover over substrate 100 in close proximity to the substrate and its growing layer. The substrate 100 has a planar surface and a two dimensional geometry. Movable element 108 moves back and forth along one direction as shown by arrows. The distance between the movable element 108 and the substrate 100 is kept to a minimum to reduce absorption losses and image distortion of the optical signals that are emitted and detected by the optical sensor integrated within movable element 108 and is directed to the substrate 100.

The movement of the movable element is restricted to maintain a constant distance between the integrated optical sensor and the substrate 100. In FIG. 1, movable element 108 is shown to be anchored at its end points by two movable struts 106. Since the two struts 106 are mechanically anchored to the movable element 108, the motion of the movable element 108 is controlled by the motion of movable struts 106 that are preferably attached to a mechanical moving apparatus.

The movement of the movable element 108 is by no means restricted to a one dimensional motion, as illustrated in FIG. 1. In principle, any other motion of movable element 108 maintaining a fixed distance between the integrated optical sensor and substrate 100 is acceptable, such as a rotational motion or a two dimensional translation.

Since the entire measurement system is immersed in a galvanic solution, the movable element acts as a stirrer to provide a homogeneous deposition of ions of the galvanic solution on substrate 100. The close proximity between the movable element and, hence, the integrated optical sensor and the substrate provide an optical inspection of the surface of substrate 100 even when the galvanic solution is highly absorptive. Moreover, by moving the optical sensor over the substrate, the layer thickness is determined at different positions on the substrate allowing to determine the uniformity of the growth of the layer.

In FIG. 1, movable element 108 is shown having an elongated shape moving in a direction perpendicular to the direction of elongation of movable element 108. When the optical sensor moves along the movable element, the entire planar surface of the substrate is inspected by the measurement system. Assuming that the deposition of ions of the galvanic solution is homogeneous, it is then sufficient that movable element 108 be displaced in only one-dimensional motion.

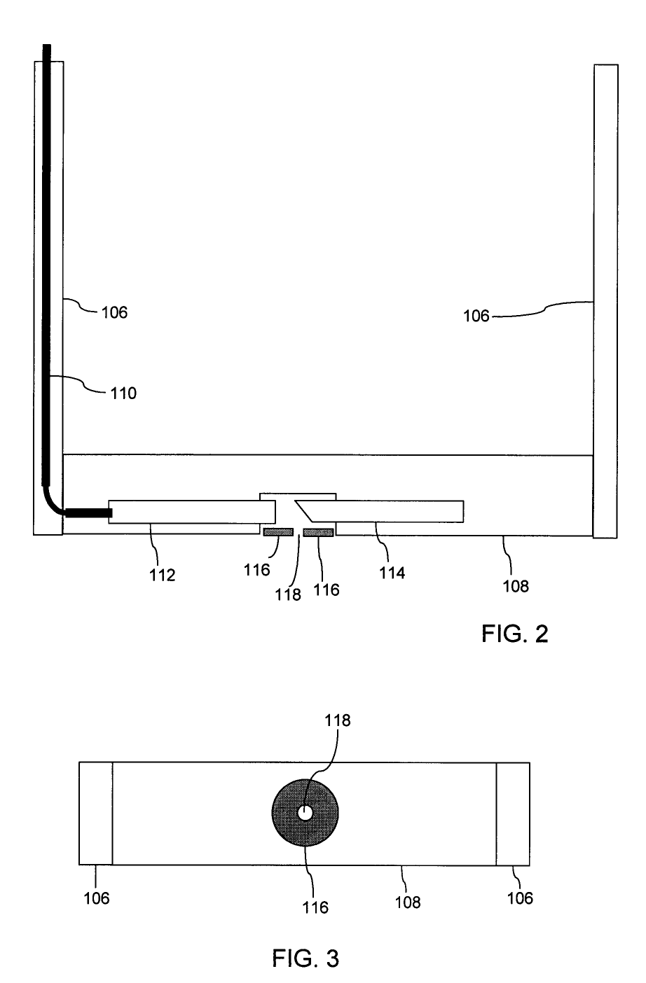

FIG. 2 is a cross-section view of the movable element and of the optical sensor. The movable element 108 is anchored to two movable struts 106 placed on either side thereof. The optical sensor, integrated into the movable element 108, has an optical fiber 110, an optical fiber head 112, a mirror 114 and a retro-reflecting element 116. The optical fiber 110 is attached to one of the movable struts or integrated into the movable strut 106. The optical fiber head 112 is connected to optical fiber 110 with a set of optical components used for the emission of optical signals and detection of optical signals. The retro-reflecting element 116 forms an aperture 118 for the emitting and incoming optical signals. Both first and second counter-propagating optical signals are reflected by the mirror 114 tilted in a 45° angle with respect to the optical path.

An optical beam emerging from the optical fiber head 112 is reflected by mirror 114, changing its direction by 90°. The optical beam then emerges from the optical sensor by propagating through aperture 118 and impinging on the surface of the substrate. Light reflected by the substrate re-enters the optical sensor in the same manner as it previously emerged. The incoming light beam is reflected by mirror 114, and redirected into the fiber head 112. The fiber head 112 is provided with means coupling the incoming light beam into the fiber 110.

FIG. 3 shows a bottom view of the movable element 108 directed toward substrate 100. The movable element 108 is anchored to the left and right to movable struts 106 and is provided with a retro-reflecting element 116. The retro-reflecting element 116 preferably features a circular shape and provides an aperture 118 at its center, although generally, retro-reflecting element 116 and aperture 118 may take any arbitrary geometry.

FIG. 4 shows a cross-section view of the movable element 108 and of the optical sensor in an operational mode. FIG. 4 resembles the cross-section view of movable element 108 illustrated in FIG. 2. Movable element 108 is provided with an optical fiber 110, an optical fiber head 112, a substantially 45° tilted mirror 114 and a retro-reflecting element 116 forming an aperture 118 for the incoming and outgoing optical signals. Substrate 100 is shown on top of electrode 104.

For illustrative purposes, the function of retro-reflector 116, optical rays 124 and 126, and reflection points 120 and 122 (where the optical rays are reflected on substrate 100 and retro-reflector 116) are specified. An optical beam emerging from fiber head 112 is reflected on mirror 114 and directed towards the substrate 100. The optical ray 124 represents the outermost ray of the optical beam impinging substrate 100 at the reflection point 120. Since the optical ray 124 impinges the substrate in a non-perpendicular way, optical ray 124 is reflected at reflection point 120, while ray 126 impacts retro-reflecting element 116 at reflection point 122. In contrast to an ordinary mirror, the retro-reflecting element reflects the optical ray in the same direction as the optical ray hitting the retro-reflecting element. Thus, the optical ray experiences a reversal in propagation direction but displays no change in direction when it is reflected by the retro-reflecting element. Therefore, ray 126 is reflected by reflection point 122 at reflection point 120 on the substrate, returning to mirror 114 propagating through aperture 118.

The retro-reflecting element has two distinct advantages: 1) the alignment requirements are effectively reduced since the optical beam is not reflected in a perpendicular direction on substrate 100. Therefore, even a non-collimated, slightly diverging beams can be used for the optical inspection of the substrate. and 2) the orientation of the mirror may slightly deviate from a tilt of 45°. The measurement system and in particular its optical sensor is therefore easy to manufacture and is significantly robust against external perturbations.

When the distance between aperture 118, substrate 100, and the divergence of the optical beam emerging from aperture 118 are such that the optical field reflected on substrate 100 does not exceed the expansion of the retro-reflecting element 116, any intensity loss is mainly caused by the absorption in the galvanic solution. In essence, the retro-reflecting element drastically increases the intensity of the optical field being subject to detection when it finally enters the optical sensor through the aperture 118.

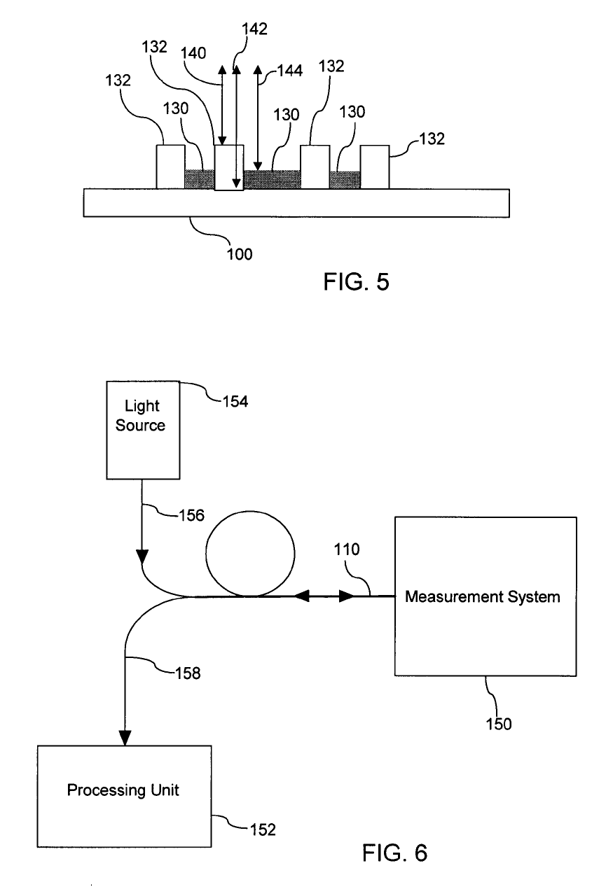

FIG. 5 is a cross-section view of substrate 100 with a layer of photoresist 132 and a layer 130 deposited by way of an electroplating process. Since substrate 100 is electrically connected to a DC voltage source representing the electrode of the electroplating apparatus, charged ions of a galvanic solution precipitate in the gaps formed by the structured photoresist 132. When the substrate 100 is subject to exposure to light, three different scenarios may arise: 1) the light beam 140 is reflected on the surface of the photoresist; 2) the light beam 142 is reflected on the surface of the substrate, propagating through the photoresist; and 3) the optical beam 144 is reflected on the surface of the deposited layer 130. From the difference in height of the point where the optical rays 140, 142 and 144 are reflected, the single optical rays become phase shifted with respect to one another. Such a phase shift is expressed in the form of an interference pattern typically subject to further analysis. By making use of white light interferometry, a plurality of wavelength components of the white light spectrum experience different phase shifts representing information that is further exploited to unequivocally determine the thickness of the layer 130.

The invention is not restricted to the thickness measurement of a growing layer 130 but it can also be applied to determine the thickness of the photoresist 132. This feature is significant since the thickness of different layers 130, 132 can thus be universally determined. In particular, measuring the thickness of the photoresist 132 prior to the execution of an electroplating process provides an efficient way of controlling the quality of the substrate 100. The invention can therefore be applied to check the quality of the substrate and provide in situ measurement of the thickness of a layer deposited thereon.

Furthermore, the inventive measurement system is not restricted to white light or optical signals in the visible range. Even infrared light sources and UV light sources can be advantageously used. The photoresist and/or the deposited layer 130 can be transparent or non-transparent for the electromagnetic radiation in use. Different materials exhibiting different transmission coefficients for a designated wavelength can be used as long as the interference pattern will be indicative of the thickness of the deposited layer 130.

FIG. 6 shows a schematic diagram of the measurement system 150 in combination with a light source 154 and a processing unit 152. The light source 154, the measurement system 150 and the processing unit 152 are, respectively connected by optical fibers 110, 156 and 158. The optical fiber 110 is attached to the measurement system, providing guidance of optical signals in either direction to and from the measurement system 150. The optical fiber 156 guides the optical signals emerging from light source 154 coupled to optical fiber 110. Optical fiber 158 provides optical signals to the processing unit coupled to the optical fiber 110. The light source 154 generates first optical signals and provides these signals through optical fiber 156 to measurement system 150 and processing unit 152. The second optical signals that are detected are provided to the processing unit by means of the optical fiber 158.

While the present invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

1. A measurement system for determining the thickness of a layer during a growth process of the layer on a substrate, the measurement system comprising:
a movable element hovering over a substrate in close proximity to said layer, and
an optical sensor for emitting first optical signals to said substrate and for detecting second optical signals reflected from said substrate.

2. The measurement system according to claim 1, wherein said optical sensor is integrated into said movable element.

3. The measurement system according to claim 1, wherein said substrate is coupled to an electrode of an electroplating cell.

4. The measurement system according to claim 1, wherein the growth process of said layer is an electroplating deposition process.

5. The measurement system according to claim 1, wherein said optical sensor comprises an optical fiber emitting said first optical signals and detecting said second optical signals, said optical fiber further transmitting said first optical signals from a source of optical signals and transmitting said second optical signals to a processing unit.

6. The measurement system according to claim 5, wherein the optical sensor further comprises a mirror for reflecting said first optical signals to said substrate and for reflecting said second optical signals to said optical fiber.

7. The measurement system according to claim 1, wherein said optical sensor further comprises a retro-reflecting element forming an aperture for said first and second optical signals, said retro-reflecting element reflecting said second optical signals to said substrate.

8. The measurement system according to claim 2, wherein said movable element has an elongated shape, and said optical sensor moves along said movable element.

9. The measurement system according to claim 1, wherein a spectral range of said first optical signals is substantially equal to the spectrum of visible light.

10. The measurement system according to claim 1, wherein said second optical signals represent a white-light interference pattern indicative of the thickness of said layer.

11. A method for determining the thickness of a layer during a growth process of the layer on a substrate, the method comprising the steps of:
hovering a movable element over said substrate in close proximity to the layer, and
emitting first optical signals from said optical sensor and detecting second optical signals by the optical sensor, said second optical signals being reflected from said substrate.

12. The method according to claim 11, wherein said optical sensor is integrated into said movable element.

13. The method according to claim 11, wherein said substrate makes electrical contact to an electrode of an electroplating cell.

14. The method according to claim 11, wherein the growth process of said layer is an electroplating deposition process.

15. The method according to claim 11, wherein said optical sensor comprises an optical fiber, the first optical signals being emitted by said optical fiber, and said second optical signals being detected by said optical fiber.

16. The method according to claim 15, wherein said first optical signals are transmitted from a source of optical signals by said optical fiber and said second optical signals are transmitted to a processing unit by said optical fiber.

17. The method according to claim 11, wherein said optical sensor further comprises a mirror, with said first optical signals being reflected by said mirror to said substrate, and said second optical signals being reflected by said mirror to said optical fiber.

18. The method according to claim 11, wherein said optical sensor further comprises a retro-reflecting element forming an aperture for said first and second optical signals, and said second optical signals are reflected to said substrate by said retro-reflecting element.

19. The method according to claim 11, wherein the spectral range of said first optical signals is substantially equal to the spectrum of visible light.

20. The method according to claim 11 wherein said second optical signals represent a white-light interference pattern indicative of the thickness of said layer.
